(19) United States
(12) Patent Application Publication
(10) Pub. No.: US 2010/0243508 A1
(43) Pub. Date: Sep. 30, 2010

(54) PRESS THROUGH PACKAGE AND ITS PRODUCTION METHOD

(75) Inventors: Tomonobu Sekiguchi, Osaka-shi (JP); Kazunori Yamada, Osaka-shi (JP); Masashi Yamamoto, Osaka-shi (JP)

Correspondence Address: BIRCH STEWART KOLASCH & BIRCH, PO BOX 747, FALLS CHURCH, VA, 22040-0747, US

(73) Assignee: TOYO ALUMINIUM KABUSHIKI KAISHA, Osaka-shi (JP)

(21) Appl. No.: 12/740,248

(22) PCT Filed: Oct. 23, 2008
(86) PCT No.: PCT/JP2008/069260

§ 371 Date: May 17, 2010

(30) Foreign Application Priority Data
Oct. 29, 2007 (JP) 2007-280781

(51) Int. Cl. B65D 83/04; B31B 1/14

(52) U.S. Cl. 206/531; 206/539; 493/63

(57) ABSTRACT

The present invention provides an easy-to-produce PTP which exhibits good hermetic sealing performance and which can be readily and reliably opened (without variation) even if the working accuracy is reduced, and also provides its production method. The PTP includes a lid member 3 having a resin film 3a, an aluminum foil 3b, and a thermal adhesive layer 3c, and a container 5 having a flange portion 5b and a large number of pocket portions 5a. The resin film 3a is provided with a plurality of cut pattern units constituting weakening point-cuts 3h arranged in a string 3j. The pitch P₁ of the weakening point-cuts 3h along the string is smaller than the pitch of the pocket portions, and at least one of the weakening point-cuts or at least a part of the weakening point-cut falls within a position corresponding to each of the pocket portions.

### TECHNICAL FIELD

The present invention relates to a press through package for enclosing, e.g., pharmaceutical products such as capsules or tablets, and more particularly to a press through package having both a press through function and an easy peel function, and its production method.

### BACKGROUND ART

Conventionally, a press through package (which may be abbreviated as “PTP” hereinafter) is formed with a lid member, made up of an aluminum foil and a thermal adhesive layer, and a container having a large number of pockets. When finger pressure is applied to a pill such as a capsule or a tablet encased in the pocket from the back of the protrusion, the aluminum foil of the lid member is ruptured so that the pill is taken out for consumption. In this case, the aluminum foil may break into fragments, and accidental ingestions of broken pieces of aluminum foil with pills have been reported. Further, there have been complaints that it is difficult for the weak, such as the elderly or the child, to press the pills out of the PTP due to their insufficient muscle strength. Moreover, in a hospital where some tens or hundreds of pharmaceutical products are handled every day, there is a demand to readily take out a large number of pills at one time.

In order to solve the above-described problems, there has been proposed a technique of forming a lid member with a stack of a plurality of layers including aluminum foil and others, and providing a partial cut or notch on a surface layer by laser beam (Patent Documents 1 and 2). With this technique, a pill can be taken out of the PTP easily with a small force.

[Patent Document 1] Japanese Patent Application Laid-Open No. 2003-063558

[Patent Document 2] Japanese Utility Model Application Laid-Open No. 1-161469

### DISCLOSURE OF THE INVENTION

### Problems to be Solved by the Invention

The technique disclosed in the above Patent Documents, however, is inadequate for the following reasons. Providing a partial cut on a surface layer in a stack by means of laser beam requires an advanced skill. Even a slight misalignment of the cut may adversely affect unsealing of the package. That is, formation of the cuts requires a high-precision work, which may deteriorate the yields. Moreover, the positions for providing the cuts cannot be specified until the positions of the pockets are determined. This means that an expensive laser rifle should be used in a post-processing step.

The present invention has been accomplished to solve the above-described problems of the conventional art, and an object of the present invention is to provide an easy-to-produce PTP which exhibits good hermetic sealing performance and which can be readily and reliably opened (without variation) even if the working accuracy is reduced, and its production method.

### Means for Solving the Problems

A PTP according to the present invention includes a lid member having a resin film, an aluminum foil, and a thermal adhesive layer, and a container having a flange portion and a large number of pocket portions. The PTP is characterized in that the resin film is provided with a plurality of cut pattern units constituting weakening point-cuts arranged in a string, and a pitch of the weakening point-cuts along the string is smaller than a pitch of the pocket portions so that at least one of the weakening point-cuts or at least a part of the weakening point-cut falls within a position corresponding to each of the pocket portions.

According to the above configuration, it is possible to provide a PTP that can readily be opened (pressed through) even in the case where the positions of the weakening point-cuts are out of alignment to some extent. The weakening point-cuts are provided only in the resin film. The sufficient strength is guaranteed by the aluminum foil and the remaining part of the resin film where the weakening point-cuts are not provided. Particularly, the aluminum foil provides perfect covering, ensuring good hermetic sealing performance. The weakening point-cut provides an origin of breakage when pressed, whereby a PTP that can be easily pressed through is obtained. In the case where the weakening point-cuts are arranged as described above, formation of the weakening point-cuts and stacking of the layers do not require high-precision processing, so that the PTP can readily be produced. Moreover, variation in press through performance between the lots, between the PTPs within a lot, and between the pocket portions within a PTP can be eliminated. It is thus possible to improve the product quality while simplifying the production. Here, generally (for industrial production), the weakening string extends in the longitudinal direction of the raw sheet of the resin film. The pitch of the weakening point-cuts along the string refers to the pitch of the centers of the weakening point-cuts (equivalent to the distance from one end of a weakening point-cut to one end in the same direction of the next weakening point-cut), and a sufficiently averaged value is taken for a plurality of PTPs. The same applies to the pitch of the pocket portions and others as well.

Preferably, the pitch of the weakening point-cuts is not greater than a half of a size of the pocket portion. This can further relax the tolerance on variation in placement accuracy of the weakening point-cuts. With rare exceptions, two or more weakening point-cuts can be arranged at each pocket portion, which further facilitates pushing out the pill. In the case where the pocket portion is in a circular shape in two dimensions, the size of the pocket portion refers to the diameter of the circular rim (inside measurement) of the flange portion surrounding the pocket portion. In the case where the pocket portion is in an oval or oblong shape rather than the circular shape, the size of the pocket portion refers to a maximum diameter of the rim (inside measurement) (equivalent to a line connecting two farthest points on the rim) of the flange portion surrounding the pocket portion.

The weakening point-cuts may be arranged in the flange portion as well. This can relax the tolerance on variation in placement accuracy of the weakening point-cuts.

For the thermal adhesive layer, an easy peel type thermal adhesive layer may be used to enhance the easy peel function. This facilitates peeling of the lid member from the container, when handling a large number of pills in a hospital or the like, so that the pills can readily be taken out in large quantities at one time.

A separating perforation may be provided to penetrate through a portion where the lid member is adhered to the flange portion of the container. This facilitates dividing the pills into a required dosage of medication.

A gripping portion in which the lid member and the container are not adhered to each other may be provided on at least one side of a periphery of the press through package. This facilitates peeling of the lid member from the container, whereby a large number of pills can readily be taken out.

The pocket portions may encase pharmaceutical products therein. This can provide the pharmaceutical products in the form where they can be stored in a hermetically sealed state, they can be easily pushed out, and they can be taken out easily in large quantities. Besides the pharmaceutical products, confectionery, health food, and others may be encased therein.

A method for producing a PTP according to the present invention is for producing a PTP that includes a lid member having a resin film, an aluminum foil, and a thermal adhesive layer, and a container having a flange portion and a large number of pocket portions. The method includes the steps of: forming in the resin film a string of weakening point-cuts with cut pattern units, such that the weakening point-cuts have a pitch smaller than a pitch of the pocket portions; stacking the resin film, the aluminum foil, and the thermal adhesive layer on one another to produce the lid member; preparing the container having the flange portion and the large number of pocket portions; and joining the lid member and the container by thermal adhesion in the state where the lid member is laid over the container such that at least one of the weakening point-cuts or at least a part of the weakening point-cut falls within a position corresponding to each of the pocket portions.

According to the above method, the weakening point-cuts are formed only in the resin film prior to stacking of the layers of the lid member. Therefore, as compared with the case where the weakening point-cuts are formed aiming at the pockets after stacking of the layers, variation in press through performance between the lots, between the PTPs within a lot, and between the pocket portions within a PTP can be reduced even in the case where the PTP is produced with a reduced accuracy. Accordingly, it is possible to improve the product quality while simplifying the production.

In the step of forming the weakening point-cuts in the resin film, the string of weakening point-cuts may be formed by using a roll having cutting protrusions corresponding to the cut pattern units arranged on a roll surface, i.e., by punching. In this manner, the arrangement of the weakening point-cuts may readily be obtained with an economically superior way.

### ADVANTAGES OF THE INVENTION

According to the present invention, it is possible to provide an easy-to-produce PTP which exhibits good hermetic sealing performance and which can be readily and reliably opened (without variation) even in the case where the working accuracy is reduced.

### BRIEF DESCRIPTION OF THE DRAWINGS

FIG. 1 is a perspective view of a PTP according to an embodiment of the present invention;

FIG. 2 is a cross-sectional view taken along the line II-II in FIG. 1;

FIG. 3 is a cross-sectional view of a lid member;

FIG. 4 is a perspective view of the PTP illustrating an arrangement pattern of weakening point-cuts in a resin film of the lid member;

FIG. 5 is a partial enlarged view of the resin film shown in FIG. 4;

FIG. 6 is a diagram of resin films showing, by way of example, arrangement patterns of weakening point-cuts, where (a) shows the case where the weakening point-cuts are dots, (b) shows the case where the weakening point-cuts are “+” signs, and (c) shows the case where they are “><” signs;

FIG. 7 is a plan view (photograph) showing the weakening point-cuts formed in a resin film by punching;

FIG. 8 is an illustration corresponding to FIG. 7;

FIG. 9 is a diagram (photograph) showing the same weakening point-cuts as in FIG. 7, which are cut (transversely) and shown from above in the direction from the center to the edge of the weakening point-cut;

FIG. 10 is an illustration corresponding to FIG. 9;

FIG. 11 is a plan view (photograph) showing the weakening point-cuts formed in a resin film by laser processing;

FIG. 12 is an illustration corresponding to FIG. 11;

FIG. 13 is a diagram (photograph) showing the same weakening point-cuts as in FIG. 11, which are cut (transversely) and shown from above in the direction from the center to the edge of the weakening point-cut;

FIG. 14 is an illustration corresponding to FIG. 13; and

FIG. 15 shows, by way of example, a method of producing a PTP of the present invention.

### DESCRIPTION OF THE REFERENCE CHARACTERS

3: lid member; 3a: resin film; 3b: aluminum foil; 3c: thermal adhesive layer; 3h: weakening point-cut; 3j: weakening point-cuts in string; 3t: non-adhered portion (flat portion of aluminum foil); 5: container; 5a: pocket portion; 5b: flange portion; 10: PTP; 21: tablet; 31: roll; D: diameter of non-adhered portion; G: gripping portion; M: perforation; P₁: pitch of weakening point-cuts; and S₁: spacing between strings of weakening point-cuts.

### BEST MODE FOR CARRYING OUT THE INVENTION

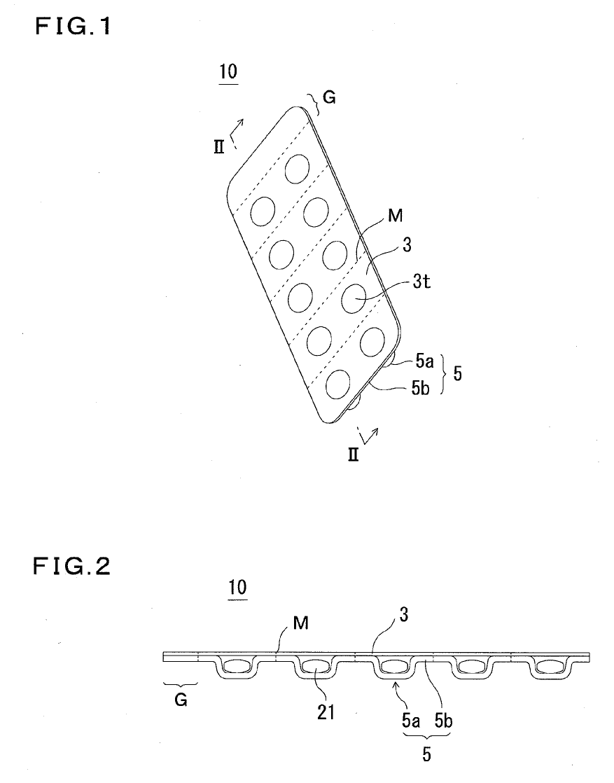

FIG. 1 is a perspective view of a PTP according to an embodiment of the present invention, which is seen from a lid member 3 side. FIG. 2 is a cross-sectional view taken along the line II-II in FIG. 1. Referring to FIGS. 1 and 2, the PTP 10 is made up of a lid member 3 and a container 5 adhered to each other, and tablets, not shown in FIG. 1, are encased in pocket portions 5a of the container 5. A flat portion of the container 5 constitutes a flange portion 5b, which abuts against and is adhered to the lid member 3. An aluminum foil of the lid member 3 is provided with circular-shaped non-adhered portions 3t, which are formed at the positions corresponding to the pocket portions 5a and each have the same size as the pocket portion 5a. The non-adhered portion 3t is flat, and constitutes an area corresponding to the pocket portion 5a. When the lid member is adhered to the flange portion 5b of the container 5, the periphery of each non-adhered portion 3t is usually adhered by press working while being applied a concavo-convex pattern, for increased adhesion strength. Such a slight concavo-convex pattern causes the non-adhered portion 3t to stand out. As seen in two dimensions, the non-adhered portions 3t approximately exactly lie over the pocket portions 5a. Five pocket portions are arranged in two rows, along the strings (not shown in FIGS. 1 and 2). To cross the strings, perforations M are provided to penetrate through the lid member 3 and the flange portion 5b of the container, so as to help remove two tablets at a time. A non-adhered, gripping portion G is provided at a side of the periphery of the PTP, to facilitate peeling of the lid member 3 from the container 5.

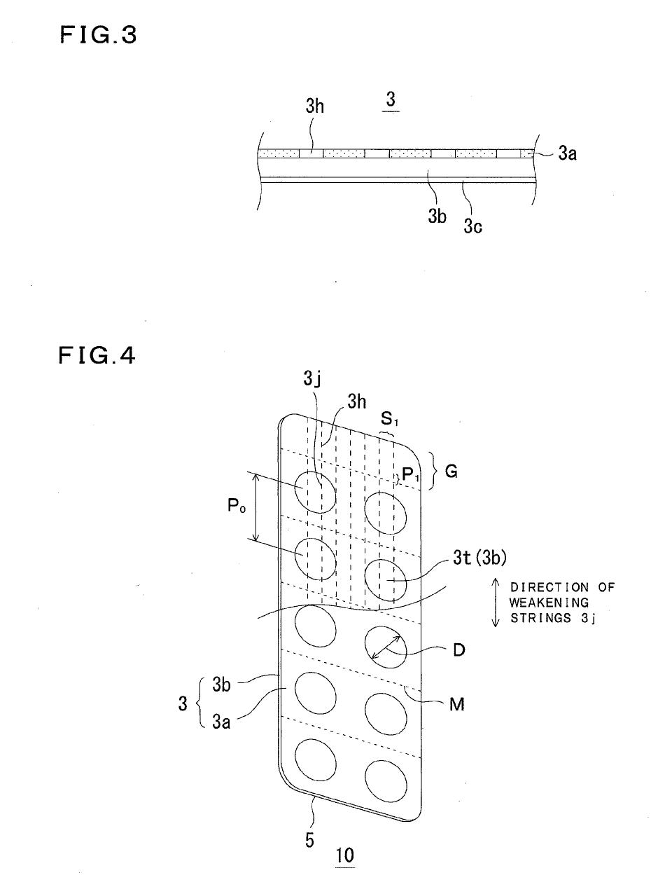

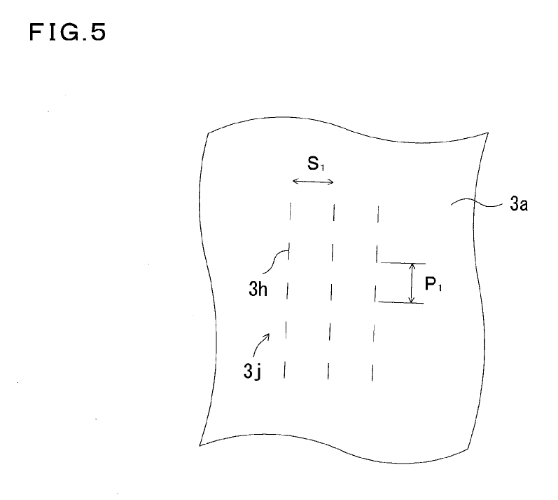

FIG. 3 is a cross-sectional view of the lid member 3. The lid member 3 is made up of a resin film 3a, an aluminum foil 3b, and a thermal adhesive layer 3c. The resin film 3a and the aluminum foil 3b are bonded to each other with an adhesive not shown. The resin film 3a is provided with cut pattern units which constitute weakening point-cuts 3h. While the resin film 3a, the aluminum foil 3b, and the thermal adhesive layer 3c are stacked in this order in the lid member 3 shown in FIG. 3, the embodiment of the present invention is not necessarily restricted thereto. The layers may be stacked for example in the order of aluminum foil, resin film, and thermal adhesive layer, although the former order (as shown in FIG. 3) is advantageous in that printing may be made on the backside of the resin film 3a (i.e., the resin film 3a+a printed layer, the aluminum foil 3b, and the thermal adhesive layer 3c are stacked in this order), and in that a variety of types of printing inks for resin film may be used. FIG. 4 is a perspective view of the PTP 10 illustrating the arrangement pattern of the weakening point-cuts 3h in the lid member 3. The lower half of the arrangement pattern of the weakening point-cuts 3h is not shown in the figure. FIG. 5 is a partial enlarged view of the resin film 3a in FIG. 4. The weakening point-cuts 3h as the cut pattern units provided in the resin film 3a are short vertical lines in the case of FIG. 4.

In the case shown in FIGS. 4 and 5, the pitch P₁ of the weakening point-cuts 3h along the string is very short, which is much smaller than the pitch P₀ of the pocket portions (not shown) or of the non-adhered portions 3t in the aluminum foil. The pitch P₁ of the weakening point-cuts is not greater than a half of the diameter D of the non-adhered portion 3t. This ensures that at least one weakening point-cut 3h falls within the position corresponding to the pocket portion. Furthermore, in the above-described arrangement pattern of the weakening point-cuts 3h, strings 3j of weakening point-cuts 3h arranged in strings have spacing S₁ (between the weakening point-cuts belonging to the neighboring strings 3j) that is not greater than a half of the diameter D of the non-adhered portion 3t. This causes a plurality of weakening strings 3j to pass through the non-adhered portion 3t. The arrangement pattern of the weakening point-cuts 3h shown in FIGS. 4 and 5 has small spacing S₁ between the weakening strings 3j and a small pitch P₁. Such spacing S₁ and pitch P₁ both guarantee that the weakening point-cuts 3h is surely arranged in the position corresponding to the pocket portion.

In the present invention, it is prerequisite that the pitch P₁ of the weakening point-cuts 3h provided in the resin film 3a is smaller than the pitch P₀ of the positions corresponding to the pocket portions, or of the non-adhered portions 3t. In the arrangement pattern of the weakening point-cuts 3h shown in FIGS. 4 and 5, the pitch P₁ and the spacing S₁ are more restricted so that a greater number of weakening point-cuts 3h are arranged at the position corresponding to the pocket portion. Each of the constituting elements of the PTP will now be described in detail.

### 1. Resin Film

The resin film 3a for use in the lid member of the PTP 10 according to the present invention preferably has a thickness of 6 to 50 μm. More preferably, the resin film 3a having a thickness of 6 to 25 μm is used. If the thickness is less than 6 μm, the strength is insufficient, in which case the film may break while the lid member is being peeled off. If the thickness exceeds 50 μm, the strength is unnecessary high, which may deteriorate the press through function. The resin film 3a having a thickness within the range of 6 to 50 μm suitably has both the press through function and the easy peel function. The resin film 3a is not restricted to a particular type; any of a variety of types of resin films including the following may be used: polyethylene film, polypropylene film, polyester film, polyamide (nylon) film, (meth)acrylic resin, polyvinyl chloride resin, polystyrene resin, polyvinylidene chloride resin, saponified ethylene-vinyl acetate copolymer, polyvinyl alcohol, polycarbonate resin, polyvinyl acetate resin, and acetal resin. The resin film may be monoaxially or biaxially oriented, or non-oriented. Particularly, from the standpoint of the press through function, the resin film preferably has an edge-tear resistance of not greater than 70 N, and more preferably from 20 to 60 N. An example of such a resin film is “TEARFINE (registered trademark) TF 110″ polyester film available from Toyobo Co., Ltd. (with edge-tear resistance of 45 N (longitudinal) and 45 N (transverse)). By using the resin film having the edge-tear resistance of not greater than 70 N (or more preferably from 20 to 60 N), it is possible to improve the press through function, while not impairing the easy peel function, whereby the individual contents can be taken out more smoothly. The edge-tear resistance may be measured in accordance with JIS C 2318 (with the specimen width of 20 mm).

### 2. Formation of Weakening Point-Cuts

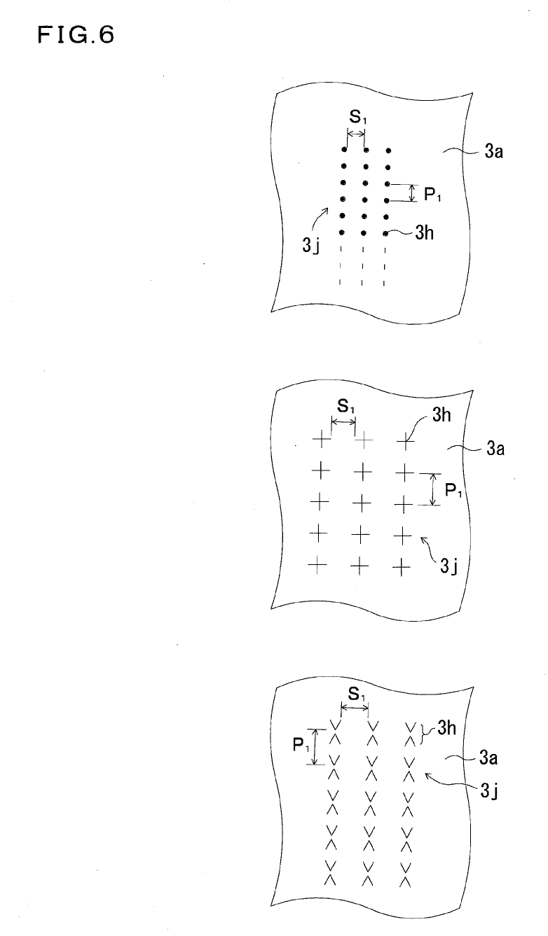

FIG. 6 provides perspective views showing, by way of example, resin films 3a provided with weakening point-cuts 3h or weakening strings 3j, in which (a) shows the case where cut pattern units constituting the weakening point-cuts 3h are dots, (b) shows the case where the weakening point-cuts are “+” signs, and (c) shows the case where they are “><” signs (although they are shown horizontally due to the limited character styles, they are actually arranged vertically). The weakening strings 3j are required to be formed in the resin film 3a before being stacked, such that they pass through the positions corresponding to the pocket portions. Preferably, two or more parallel weakening strings 3j are formed. While the number of weakening strings 3j may be set as appropriate according to need, preferably one to ten lines (strings) per pocket are arranged, with spacing between the weakening strings 3j of about 0.3 mm to about 50 mm, and more preferably about 0.5 mm to about 20 mm. The weakening strings are preferably approximately parallel to each other. While the individual weakening point-cuts forming the weakening strings may be simple perforations, they may be formed with any arbitrary sign or character, including those shown in (a) to (c) in FIG. 6, such as “+”, “×”, “÷”, “•”, [symbol] (separate lines)”, “V”, “>< (although they are shown horizontally due to the limited character styles, they are actually arranged vertically)”, “/”, and others. The size of the weakening point-cut 3h is preferably about 0.05 mm to about 20 mm in maximum length, and the pitch P₁ of the weakening point-cut 3h may be generally about 0.5 mm to about 20 mm. While each weakening point-cut 3h preferably penetrates all through the resin film 3a, it does not necessarily have to completely penetrate through the film; so-called half cut will do. Although the way of forming the weakening strings 3j or weakening point-cuts 3h is not particularly limited, a roll having protrusions of the same shapes as the weakening point-cuts 3h may be brought into contact with the resin film, for example.

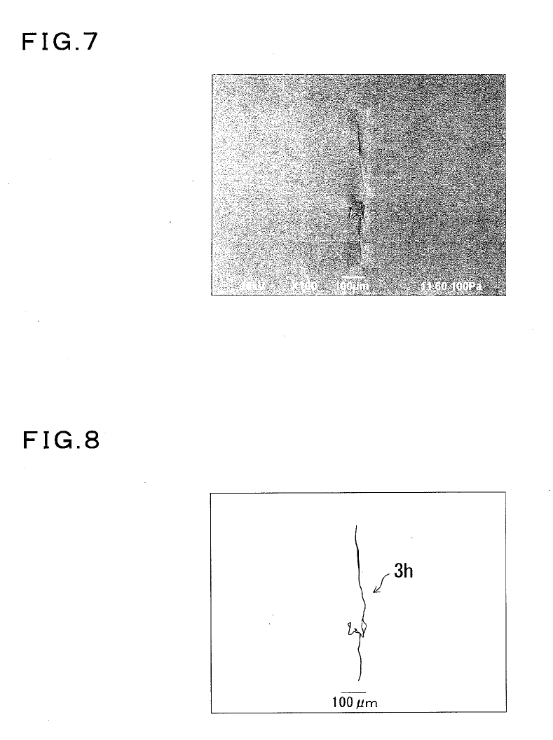

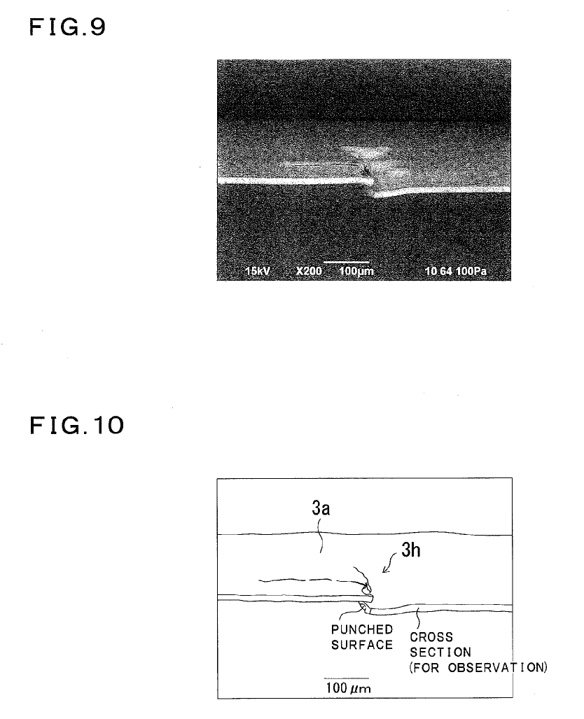

FIG. 7 is a plan view (photograph) showing the weakening point-cuts 3h formed in the resin film 3a by punching using a roll having protrusions, and FIG. 8 is an illustration thereof. The photograph is an image taken by a scanning electron microscope (SEM) at an accelerating voltage of 15 kV; the same applies to the subsequent photographs. FIG. 9 is a diagram (photograph) of the same weakening point-cuts 3h, which are cut transversely and seen from diagonally above in the direction from the center to the edge of the weakening point-cut 3h, and FIG. 10 is an illustration thereof. According to the punching process, the edge of the weakening point-cut 3h becomes sharp, and when a pill is to be pressed out, a high stress concentrates onto the edge of the weakening point-cut 3h, leading to improved press through performance.

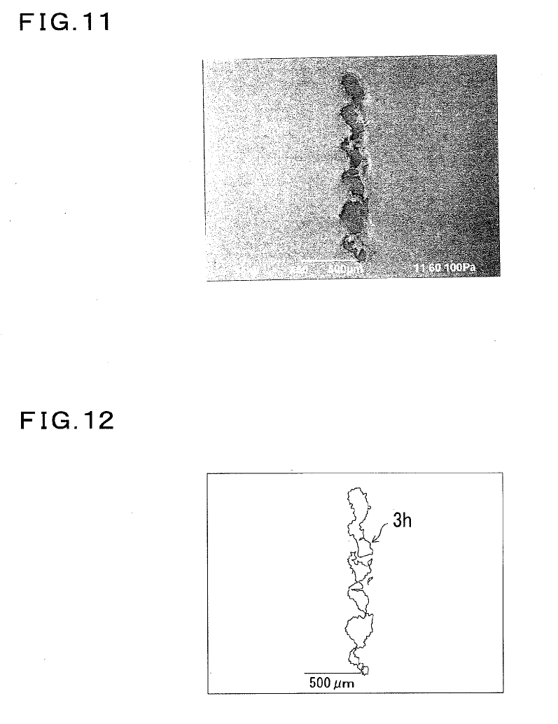

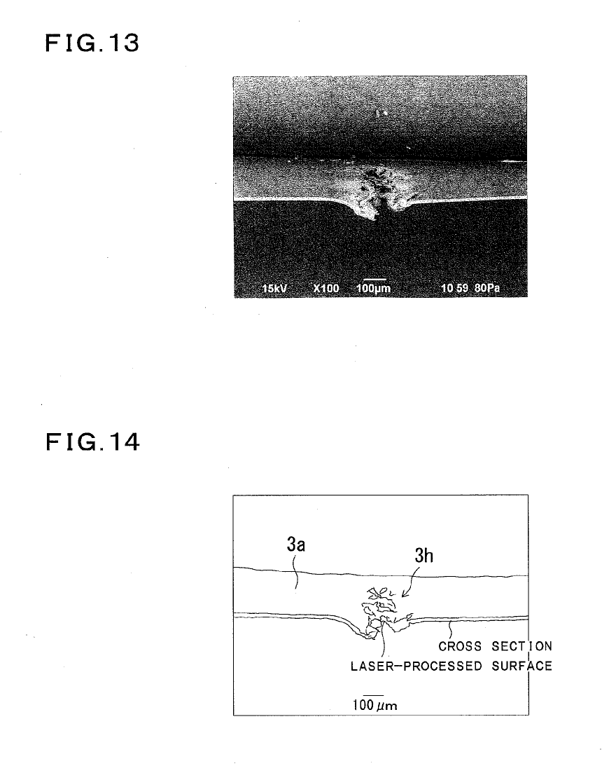

FIG. 11 is a plan view (photograph) showing the weakening point-cuts 3h formed in the resin film 3a by laser processing, and FIG. 12 is an illustration thereof. FIG. 13 is a diagram (photograph) of the same weakening point-cuts 3h, which are cut across it and seen from diagonally above in the direction from the center to the edge of the weakening point-cut 3h, and FIG. 14 is an illustration thereof. According to the laser processing, the resin film 3a is molten to form the weakening point-cut 3h, resulting in an edge not as sharp as that obtained by punching. The actual press through performance is still high, and the weakening point-cuts 3h formed are in a practical use level. Either punching or laser processing may be selected, taking into consideration all the conditions of the existing facilities, the types of the resin film 3a and the aluminum foil 3b being used, the density of arrangement of the weakening point-cuts 3h, and others.

### 3. Aluminum Foil

The aluminum foil 3b for use in the lid member 3 of the PTP 10 according to the present invention may be the same as the one used for a known PTP. For example, a hard material, such as (JIS) 1N30, 8021, or 8079, having a thickness of about 10 μm to about 30 μm may be used. Aluminum foils other than those defined by JIS and the like, for example an aluminum alloy foil like an Al—Mn-based alloy, may be used as well. Although the way of stacking the aluminum foil and the resin film is not particularly restricted, dry lamination using a dry laminate adhesive is employed preferably.

### 4. Thermal Adhesive Layer

The thermal adhesive layer 3c for use in the lid member 3 of the PTP 10 according to the present invention is preferably an easy peel type thermal adhesive resin. For example, ethylene-vinyl acetate copolymer film (EVA), ethylene-methacrylic acid copolymer (EMAA), a blended resin of polyethylene and polybutene, a resin obtained by mixing 10 to 90 parts by weight of EMAA resin or ethylene copolymer like the EMAA resin with 90 to 10 parts by weight of PP resin, or CMPS VN-503 (trade name; available from Dupont-Mitsui Polychemicals Co., Ltd.) may be used. The easy peel type thermal adhesive resin is preferably applied to one surface of the aluminum foil facing the container, to achieve a dry weight of about 2 g/m² to about 15 g/m².

### 5. Surface of Lid Member Etc.

The lid member 3 of the PTP according to the present invention may be applied with printing or coloring, in addition to those described above. An OP (overprint) layer, a primer layer, an anchor coat layer, and the like may be stacked according to need. A surface of any layer may be coated with any of anti-fog agent, slip agent, anti-slip agent, or other coating agents. Moreover, paper, synthetic paper, and the like may be stacked as long as they do not impair the effects of the present invention. Needless to say, the way of stacking the layers is not restricted to those described above; any known method may be employed.

### 6. Container

The container 5 for use in the PTP 10 according to the present invention is a known container having a large number of pocket portions 5a surrounded by a flange portion 5b. The container may be formed with a resin sheet of polypropylene, vinyl chloride, or the like, by plug-assist forming, vacuum or air-pressure forming, vacuum/pressure forming, hot press forming, or the like. A commercially available PTP container may be used as well. After pharmaceutical products such as tablets or capsules (contents) are encased in the container, the opening is covered with the lid member and sealed by thermal adhesion, whereby the package of the present invention can be provided. The lid member may be applied to cover the opening in such a manner that the weakening string passes over the opening. It is very easy to do so, because a plurality of weakening strings are provided continually.

### 7. Perforations and Gripping Portion

The PTP 10 according to the present invention may be provided with separating perforations M, as in the case of the commercially available PTP, to penetrate through the portion where the lid member 3 and the container 5 are adhered to each other. The perforations may be used to divide the pills into a dosage of medication or to provide a required amount of pills. A gripping portion G as shown in FIGS. 1 and 4 may be provided on at least one side of the periphery of the PTP. The gripping portion G may be pinched with the fingers to readily peel off the lid member. The peeling direction is preferably made to coincide with the direction in which the weakening strings 3j extend, which prevents slip-stick phenomenon or breakage during the peeling operation of the lid member, thereby ensuring good easy peel performance. At the gripping portion G, it is desirable that the lid member and the container 5 are separate from each other in advance. Alternatively, no thermal adhesive layer 3c may be provided at this portion, a thermal adhesive may be applied in an extremely small amount at the portion, the area for applying the thermal adhesive may be adjusted, or a release agent may be mixed into, or laminated on, the thermal adhesive applied to the portion, to facilitate formation of the gripping portion G.

### 8. Production Method

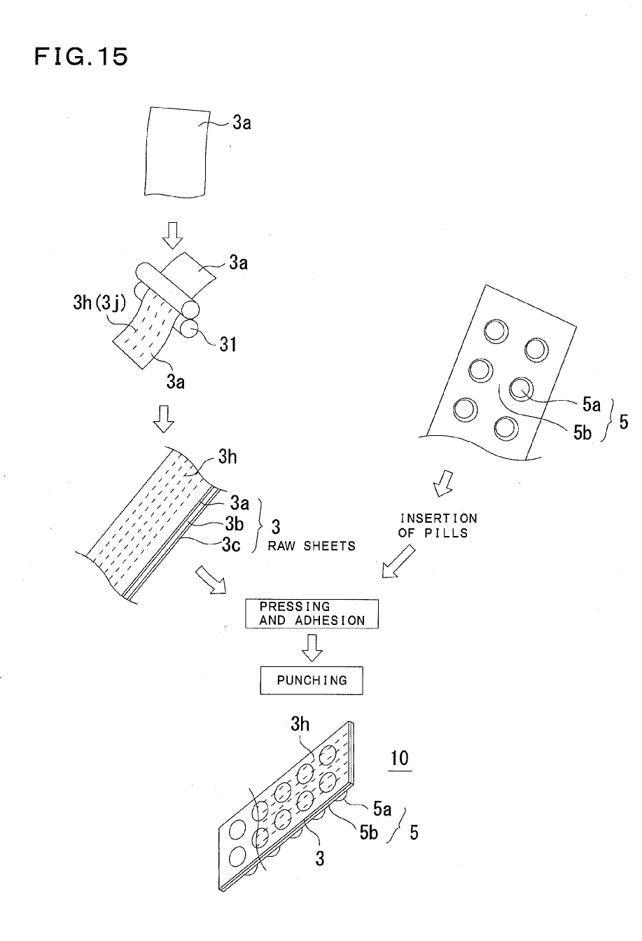

FIG. 15 shows a method for producing a PTP according to the present invention. According to this production method, weakening point-cuts 3h or weakening strings 3j are formed in a resin film 3a. In FIG. 15, the weakening point-cuts 3h are formed using a roll, as described above, although they may be formed, not using the roll, but by laser processing for example. Subsequently, the resin film 3a provided with the weakening point-cuts 3h, an aluminum foil 3b, and a thermal adhesive layer 3c are stacked on one another to form a lid member 3 in the form of a stack. At the time of adhesion, usually, non-adhered portions 3t are eventually formed in the aluminum foil 3b, at the portions corresponding to the pocket portions. Although not shown in FIG. 15, the lid member 3 is preferably provided with a gripping portion G and perforations M. The lid member 3 is punched into a size conforming to a predetermined specification of the PTP 10 at any time point (for example after the lid member is adhered to a container), and finally, the lid member 3 integrated with the container 5 according to the predetermined specification is produced.

For formation of the container 5, a resin of a predetermined material may be processed to have pocket portions 5a and a flange portion 5b, although a commercially available container may be used, as described above. For production of the PTP 10, pharmaceutical products may be inserted into the pocket portions 5a of the container 5, and the lid member 3 may be aligned and adhered thereto. Thereafter, the stack may be punched into a size conforming to a specification, whereby the PTP 10 according to the predetermined specification is completed. While the punching is the final step in this example, in the case of batch processing for example, the punching may be performed prior to the pill insertion step or the adhesion step, as long as it does not impair the effects of the present invention.

In the method of producing the PTP shown in FIG. 15, the following two points are essential.

(1) Firstly, weakening point-cuts 3h or weakening strings 3j are formed only in the resin film 3a.
(2) At this time, the weakening point-cuts 3h are formed in the arrangement pattern as described above in detail.
According to (1) above, the weakening point-cuts are formed before formation of the stacked body of the lid member 3. This means that when the weakening point-cuts 3h are formed, they would not penetrate through the entire thickness of the lid member 3 or damage the aluminum foil. As a result, the interior of each pocket portion is prevented from being adversely affected by moisture during storage. According to (2) above, it is unnecessary to carefully place each weakening point-cut 3h in the position corresponding to each pocket portion. This can greatly relax the tolerance on placement accuracy. Substantially a great number of weakening point-cuts can be provided not restricted to the pocket portions, as in (2) above, because the production method used completely eliminates the possibility that the weakening point-cuts penetrate through the entire thickness of the lid member 3 or damage the aluminum foil 3b, as in (1) above. No problem will arise even if substantially a great number of weakening point-cuts are provided.

### EXAMPLES

The functions and effects of the present invention will now be described with reference to examples. As specimens, Inventive Examples 1 to 10 according to the present invention and Comparative Examples 1 to 4 were used. A common container was used for each specimen, with the pocket portions in the container having a pitch of 17 mm and a size of 10 mm. The specimens will now be described.

### Inventive Examples 1 to 10

A roll provided with protrusions was used to form weakening strings in a 9 to 12 μm-thick PET film (polyethylene terephthalate film) for each of Inventive Examples 1 to 9, and in a 14 μm-thick polyester film (TEARFINE (registered trademark) described above) for Inventive Example 10. The shapes and sizes (maximum lengths per point) of the weakening point-cuts are as shown in Table 1. A 17 to 20 μm-thick aluminum foil (1N30, hard foil) was laminated by dry lamination using a polyurethane adhesive (with a dry weight of 1.5 g/m²), and then, on the aluminum foil surface, a wax-added polypropylene easy peel type thermal adhesive was applied to have a dry weight of 5 g/m², whereby the lid member for each of Inventive Examples 1 to 10 was formed. Tablets, 8 mm in diameter, were housed in a plurality of pockets formed in a polypropylene PTP container, which was then heat-sealed by each of the above-described lid members at 100° C. to produce the PTP package. According to Table 1, as will be shown below, the pitch of the weakening point-cuts in each specimen of Inventive Examples 1 to 10 is smaller than the pitch, 17 mm, of the pocket portions of the container, thereby satisfying the requirement of the present invention.

### Comparative Example 1

The PTP package was produced in a similar manner as in Inventive Example 1, except that the weakening strings were not formed.

### Comparative Example 2

An overprint (OP) agent was applied in a thickness of about 1 μm on one surface of a 20 μm-thick aluminum foil (1N30, hard foil), and an ethylene-vinyl alcohol (EVA)-added polypropylene thermal adhesive was applied in a dry weight of 5 g/m² on the other surface of the aluminum foil, to form the lid member of Comparative Example 2. Tablets, 8 mm in diameter, were housed in a plurality of pockets formed in a polypropylene PTP container, which was then heat-sealed by the lid member at 100° C. to produce the PTP package.

### Comparative Example 3

An overprint (OP) agent was applied in a thickness of about 1 μm on one surface of a 20 μm-thick aluminum foil (1N30, hard foil) and, on the other surface of the aluminum foil, a 30 μm-thick co-extrusion easy peel type thermal adhesive film, made up of polypropylene/polyethylene/polystyrene alloy graft polymer resin, was laminated by dry lamination using a polyurethane adhesive (with a dry weight of 3 g/m²), to form the lid member of Comparative Example 3. Tablets, 8 mm in diameter, were housed in a plurality of pockets formed in a polypropylene PTP container, which was then heat-sealed by the lid member at 100° C. to produce the PTP package.

### Comparative Example 4

An overprint (OP) agent was applied in a thickness of about 1 μm on one surface of a 20 μm-thick aluminum foil (1N30, hard foil), and a polypropylene easy peel type thermal adhesive was applied in a dry weight of 5 g/m² on the other surface of the aluminum foil, to form the lid member of Comparative Example 4. Tablets, 8 mm in diameter, were housed in a plurality of pockets formed in a polypropylene PTP container, which was then heat-sealed by the lid member at 100° C. to produce the PTP package.

A press through test and an easy peel test were conducted for each of the above-described specimens. The tests are as follows.

### 1. Press Through Test

Finger pressure was applied onto the bottom (the pocket portion opposite from the lid member) of the container of each package to see whether the tablet can be pushed out through the lid member. Evaluation results are shown using the following symbols:

0: The tablet can be taken out with no problem.
x: The tablet cannot be pushed out through the lid member.

### 2. Easy Peel Test

An end of the lid member of each package was pinched with the fingers and pulled, to see whether the lid member can be peeled from the container. Evaluation results are shown using the following symbols:

0: The lid member is peeled off with no problem, and the tablet can be taken out.
x: The lid member is not peeled off even if force is applied, and the tablet cannot be taken out.
xx: The lid member is broken and cannot be opened.

TABLE 1

| | | Size of | Pitch of | Spacing | | | | |
|---|---|---|---|---|---|---|---|---|
| | Shape of | Weakening | Weakening | between | | | Press | |
| | Weakening | Point-cut | Point-cut | Weakening | Weakening | Structure of | Through | Easy Peel |
| | Point-cut | (mm) | (mm) | Strings (mm) | Strings | Lid Member | Test | Test |
| Inventive | + | 6 | 10 | 14 | ++++ | 9PET/D/17AL/EP1 | ◯ | ◯ |
| Example 1 | | | | | | | | |
| Inventive | × | 6 | 15 | 10 | ×××× | 9PET/D/17AL/EP1 | ◯ | ◯ |
| Example 2 | | | | | | | | |
| Inventive | ÷ | 3 | 3 | 2 | ÷÷÷÷ | 9PET/D/17AL/EP1 | ◯ | ◯ |
| Example 3 | | | | | | | | |
| Inventive | . | 0.2 | 3 | 3 | .... | 9PET/D/17AL/EP1 | ◯ | ◯ |
| Example 4 | | | | | | | | |
| Inventive | \| | 0.5 | 2.5 | 3 | \|\|\|\| | 9PET/D/17AL/EP1 | ◯ | ◯ |
| Example 5 | | | | | | | | |
| Inventive | [symbol] | 4 | 6 | 8 | [symbol] [symbol] [symbol] [symbol] | 12PET/D/20AL/EP1 | ◯ | ◯ |
| Example 6 | | | | | | | | |
| Inventive | [symbol] | 7 | 9 | 7 | <<<< | 12PET/D/20AL/EP1 | ◯ | ◯ |
| Example 7 | | | | | | | | |
| Inventive | [symbol] | 10 | 14 | 11 | ><>< | 12PET/D/20AL/EP1 | ◯ | ◯ |
| Example 8 | | | | | | | | |
| Inventive | \ | 3 | 5 | 15 | //// | 12PET/D/20AL/EP1 | ◯ | ◯ |
| Example 9 | | | | | | | | |
| Inventive | [symbol] | 0.15 | 2 | 2 | ---- | 14TF/D/20AL/EP1 | ◯ | ◯ |
| Example 10 | | | | | | | | |
| Comparative | none | | | | none | 9PET/D/17AL/EP1 | X | ◯ |
| Example 1 | | | | | | | | |
| Comparative | none | | | | none | OP/20AL/HT | ◯ | X |
| Example 2 | | | | | | | | |
| Comparative | none | | | | none | OP/20AL/D/EP2 | X | ◯ |
| Example 3 | | | | | | | | |
| Comparative | none | | | | none | OP/20AL/EP3 | ◯ | XX |
| Example 4 | | | | | | | | |

Note 1)
The size of the weakening point-cut refers to the maximum length of the continued portion of one weakening point-cut.
Note 2)
For Inventive Examples 3, 6, and 8, “÷”, “ [symbol] (separate lines)”, and “><” are each counted as one weakening point-cut.
Note 3)
PET: polyethylene terephthalate film (with the number representing the thickness in μm)
TF: polyester film “TEARFINE ® TF110” available from Toyobo Co., Ltd.
D: polyurethane dry laminate adhesive
AL: aluminum foil (with the number representing the thickness in μm)
EP1: wax-added polypropylene easy peel type thermal adhesive
EP2: co-extrusion easy peel type thermal adhesive film
EP3: polypropylene easy peel type thermal adhesive
HT: ethylene-vinyl alcohol (EVA)-added polypropylene thermal adhesive
OP: overprint (overcoat)

The results of the tests described above are shown in Table 1. According to the same, Inventive Examples 1 to 10 exhibited good results in both of the press through test and the easy peel test, without exception. Particularly, even in Inventive Examples 6 to 10 where the resin film and the aluminum foil were increased in thickness, good press through performance was obtained with no problem. In contrast, it is understood that, in Comparative Examples provided with no weakening point-cuts, the press through performance is inferior for example in Comparative Example 1 where a resin film was arranged. As to the easy peel test, degradation in performance is evident in the case where no easy peel type thermal adhesive layer is provided.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

According to the PTP and its production method of the present invention, it is possible to obtain a high-quality product which can readily be opened, without variation in press through performance between the lots, between the PTPs within one lot, or between the pocket portions within one PTP, even in the case where the working accuracy is reduced, whereby their contribution to the field is expected.

1. A press through package, comprising a lid member having a resin film, an aluminum foil, and a thermal adhesive layer, and a container having a flange portion and a large number of pocket portions, wherein
said resin film is provided with a plurality of cut pattern units constituting weakening point-cuts arranged in a string, a pitch of said weakening point-cuts along said string being smaller than a pitch of said pocket portions such that at least one of said weakening point-cuts or at least a part of said weakening point-cut falls within a position corresponding to each of said pocket portions.

2. The press through package according to claim 1, wherein the pitch of said weakening point-cuts is not greater than a half of a size of said pocket portion.

3. The press through package according to claim 1, wherein said weakening point-cuts are located in said flange portion as well.

4. The press through package according to claim 1, wherein said thermal adhesive layer is an easy peel type thermal adhesive layer.

5. The press through package according to claim 1, having a separating perforation provided to penetrate through a portion where said lid member and the flange portion of said container are adhered to each other.

6. The press through package according to claim 1, wherein a gripping portion in which said lid member and said container are not adhered to each other is provided on at least a side of a periphery of said press through package.

7. The press through package according to claim 1, wherein said pocket portions encase pharmaceutical products therein.

8. A method for producing a press through package, the press through package including a lid member having a resin film, an aluminum foil, and a thermal adhesive layer, and a container having a flange portion and a large number of pocket portions, the method comprising the steps of:
forming in said resin film a string of weakening point-cuts with cut pattern units, such that said weakening point-cuts have a pitch smaller than a pitch of said pocket portions;
stacking said resin film, the aluminum foil, and the thermal adhesive layer on one another to produce the lid member;
preparing said container having the flange portion and the large number of pocket portions; and
joining said lid member and said container by thermal adhesion in the state where said lid member is laid over said container such that at least one of said weakening point-cuts or at least a part of said weakening point-cut falls within a position corresponding to each of said pocket portions.

9. The method for producing a press through package according to claim 8, wherein said step of forming the weakening point-cuts in said resin film includes the step of forming said string of weakening point-cuts by using a roll having cutting protrusions corresponding to said cut pattern units arranged on a roll surface.
